(19) United States
(12) Patent Application Publication
(10) Pub. No.: US 2016/0298813 A1
(43) Pub. Date: Oct. 13, 2016

(54) MULTIPLE COLOR HOMOGENIZATION SYSTEM FOR AN LED LUMINAIRE

(71) Applicant: ROBE LIGHTING, INC., Sunrise, FL (US)

(72) Inventors: Pavel JURIK, Prostredni Becva (CZ); Josef VALCHAR, MULTIPLE COLOR HOMOGENIZATION SYSTEM FOR (CZ)

(73) Assignee: Robe Lighting, Austin, TX (US)

(21) Appl. No.: 15/026,903

(22) PCT Filed: Oct. 1, 2014
(86) PCT No.: PCT/US14/58686

§ 371 Date: Apr. 1, 2016

Related U.S. Application Data
(60) Provisional application No. 61/885,034, filed on Oct. 1, 2013.

(51) Int. Cl. F21K 99/00; F21V 7/00; G02B 17/00; H05B 33/08; G02B 19/00; F21V 14/06; G02B 3/00; F21V 11/18; F21V 5/00

(52) U.S. Cl. CPC F21K 9/54; F21V 11/186; F21K 9/58; F21V 7/0091; G02B 17/006; F21V 5/008; G02B 19/0061; F21V 14/06; G02B 3/00; H05B 33/0863; F21Y 2105/003

(57) ABSTRACT

Described are unigue LED die and die on circuit board configurations used in combination with elongated homogenizers to achieve uniform lights with a wider color gamut.

### RELATED APPLICATION

The present application claims priority of:

PCT/US14/58686 international application filed 1 Oct. 2014 claiming, 61/885,034 provisional application filed 1 Oct. 2013.

### TECHNICAL FIELD OF THE INVENTION

The present invention generally relates to a method for controlling the light output from an array of LEDs when used in a light beam producing luminaire, specifically to a method relating to improving the homogenization and collimation of the LEDs and for controlling the beam angle of the array.

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. A typical product will typically provide control over the pan and tilt functions of the luminaire allowing the operator to control the direction the luminaire is pointing and thus the position of the light beam on the stage or in the studio. This position control is often done via control of the luminaire's position in two orthogonal rotational axes usually referred to as pan and tilt. Many products provide control over other parameters such as the intensity, color, focus, beam size, beam shape and beam pattern. Additionally it is becoming common to utilize high power LEDs as the light source in such luminaires and, for color control, it is common to use an array of LEDs of different colors. For example a common configuration is to use a mix of Red, Green and Blue LEDs. This configuration allows the user to create the color they desire by mixing appropriate levels of the three colors. For example illuminating the Red and Green LEDs while leaving the Blue extinguished will result in an output that appears Yellow. Similarly Red and Blue will result in Magenta and Blue and Green will result in Cyan. By judicious control of the LED controls the user may achieve any color they desire within the color gamut set by the LED colors in the array. More than three colors may also be used and it is well known to add an Amber or White LED to the Red, Green and Blue to enhance the color mixing and improve the gamut of colors available. The products manufactured by Robe Show Lighting such as the Robin 600 LEDWash are typical of the art.

The differently colored LED dies may be arranged on packages in the luminaire such that there is physical separation between each color of LED, and this separation, coupled with differences in die size for each color, may affect the spread of the individual colors and results in inadequate mixing of the different colors along with objectionable spill light and color fringing of the combined mixed color output beam. It is common to use a lens or other optical device in front of each LED package to control the beam shape and angle of the output beam; however these optical devices may have differing effect for different colors and color fringing or other aberrations may be visible in the output beam. It would be advantageous to have a system where stray light and aberrations are well controlled.

FIG. 1 illustrates a prior art system showing two LEDs in a package as may be used in a luminaire. LED 2 and LED 4 may be of differing colors and, due to the different optical properties and construction of the LED dies 2, 4 produce light beams 6 and 8 that differ in beam spread. The differing beam spreads mean that the light beams from LEDs 2 and 4 will impinge on an illuminated object 18 in such a way that areas 20 and 16 of the object are illuminated by a single LED only rather than the desired mix of both. This results in areas 120 and 16 being colored differently from the central mixed area and appearing as colored fringes. Only Two (2) LEDs are illustrated in FIG. 1 for clarity and simplicity. It should be appreciated that the same problem exists with systems incorporating more than two colors of LED.

FIG. 2 illustrates a typical multiparameter automated LED luminaire system 10. These systems commonly include a plurality of multiparameter automated luminaires 12 which typically each contain on-board an array of LEDs, and electric motors coupled to mechanical drives systems and control electronics (not shown). In addition to being connected to mains power either directly or through a power distribution system (not shown), each luminaire is connected is series or in parallel to data link 14 to one or more control desk(s) 15. The luminaire system 10 is typically controlled by an operator through the control desk 15. Consequently, to affect this control, both the control desk 10 and the individual luminaires typically include electronic circuitry as part of the electromechanical control system for controlling the automated lighting parameters.

FIG. 3 and FIG. 4 illustrate an optical system used in the prior art to provide a variable beam angle or zoom to an automated LED luminaire. Each LED 50 which may be fitted with a primary optic 52 has an associated pair of lenses 53 and 55. Lenses 53 and 55 may be separate lenses or each part of an array of lenses covering the entire LED array. Lenses 53 and 55 may each comprise a single optical element 56 and 57 respectively. In operation at least one of lens 53 or lens 55 is stationary with respect to LED 50 while the other may move along optical axis 59. In the example illustrated in FIGS. 3 and 4 lens 55 is fixed relative to LED 50 while lens 53 is able to move along optical axis 59. FIG. 3 shows lens 53 in a first position and FIG. 4 shows lens 53 in a second position closer to LED 50. This varying relative position between LED 50, lens 53 and lens 55 provides a beam angle or zoom to the light beam from LED 50. Such systems are often limited in their zoom range by optical problems caused by the color separation and inadequate beam homogenization. They may further be limited by requiring large movements of the lenses.

This is a need for an optical system for an LED automated luminaire which provides improved color homogenization and beam collimation while also providing improved zoom range.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a prior art LED lighting system;

FIG. 2 illustrates a typical automated lighting system;

FIG. 3 illustrates optical components of a prior art LED luminaire;

FIG. 4 illustrates optical components of a prior art LED luminaire;

FIG. 5 illustrates optical components of an embodiment of the LED luminaire;

FIG. 6 illustrates a front view of the collimating and mixing optic 80 and LED 60 of FIG. 5;

FIG. 7 illustrates a front view of the light integrator 102 of FIG. 5;

FIG. 8 illustrates a further embodiment of the embodiment illustrated in FIG. 5;

FIG. 9 illustrates an alternative embodiment of the LED luminaire;

FIG. 10 illustrates a front view of the collimating and mixing optic 80 and LED 60 of FIG. 5;

FIG. 11 illustrates a front view of the light integrator 102 of FIG. 5;

FIG. 12 illustrates a further embodiment of the embodiment illustrated in FIG. 5;

FIG. 13 illustrates an alternative embodiment of the LED luminaire illustrated in FIG. 5;

FIG. 14 illustrates an alternative embodiment of the LED luminaire illustrated in FIG. 9;

FIG. 15 illustrates an alternative embodiment of the LED luminaire;

FIG. 16 illustrates the alternative LED configuration layout;

FIG. 17 illustrates details of an embodiment of an LED configuration layout;

FIG. 18 illustrates details of an embodiment of an LED configuration layout; and

FIG. 19 illustrates a CIE color chart showing potential LED color choices for the previously discussed embodiments.

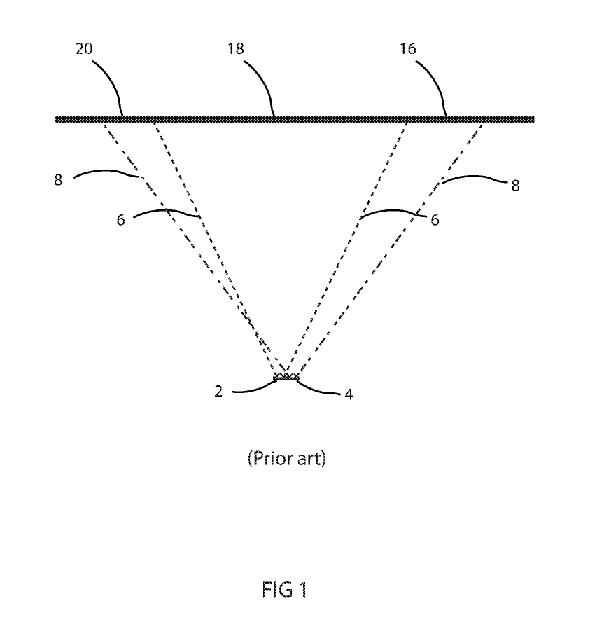

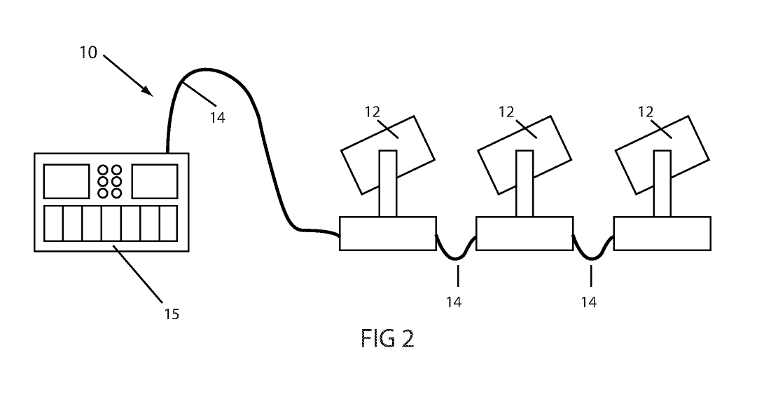

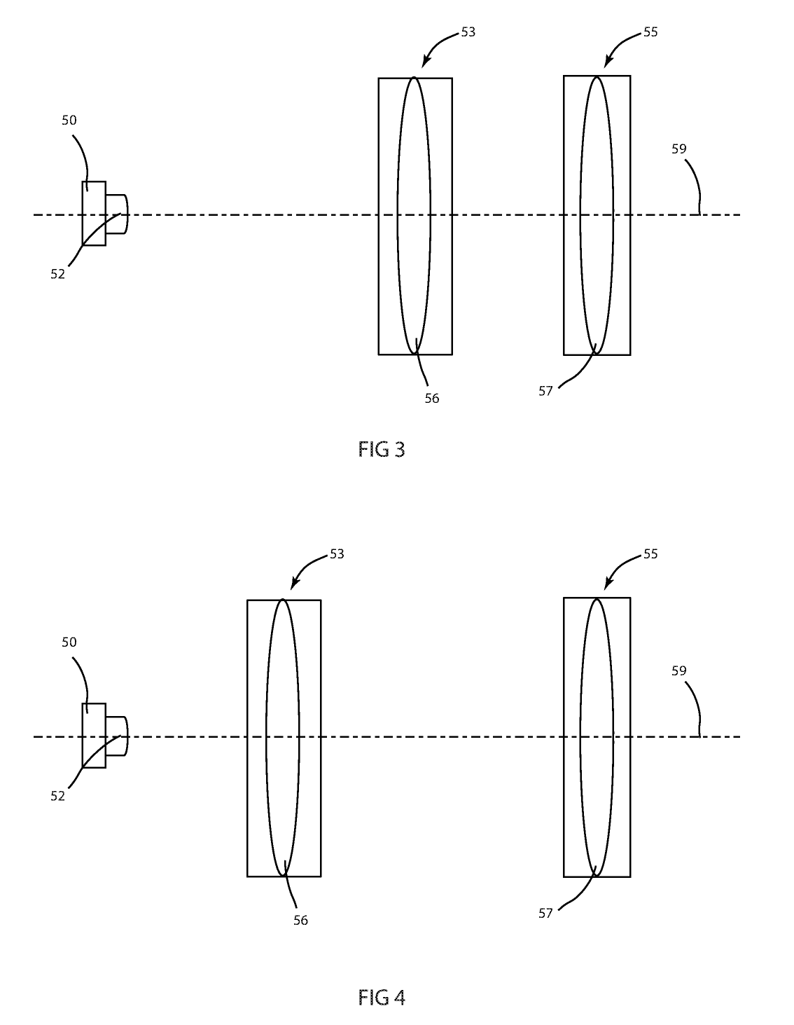

### DETAILED DESCRIPTION OF THE INVENTION

Preferred embodiments of the present invention are illustrated in the FIGUREs, like numerals being used to refer to like and corresponding parts of the various drawings.

The present invention generally relates to a method for controlling the light output from an array of LEDs when used in a light beam producing luminaire, specifically to a method relating to improving the homogenization and collimation of the LEDs and for controlling the beam angle of the array.

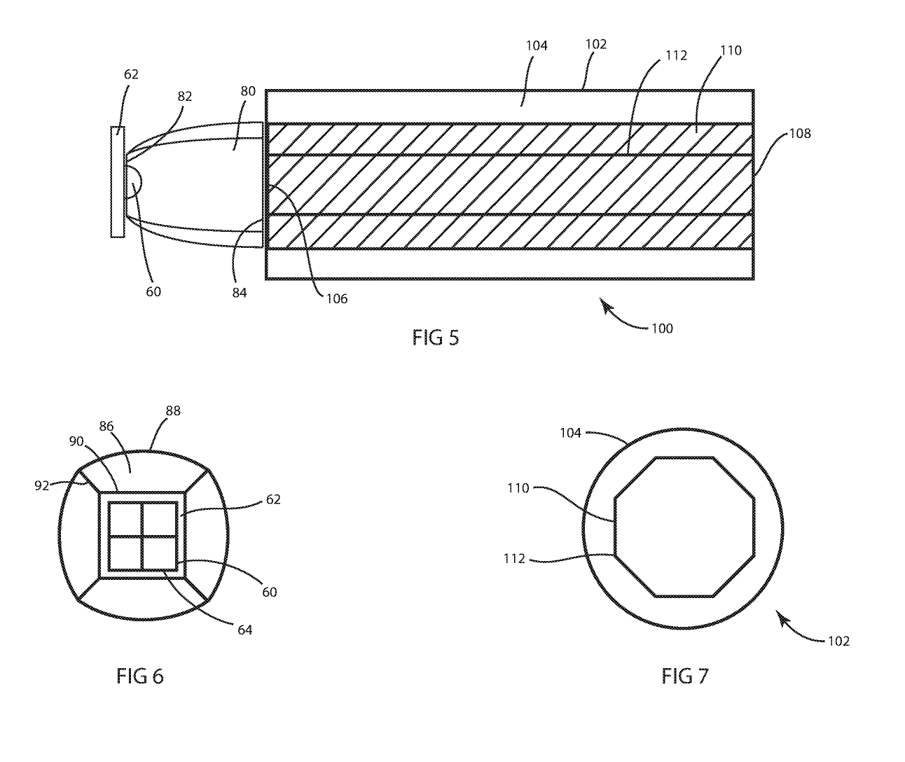

FIG. 5 illustrates an embodiment of the optical system of the invention. LED 60, which may include a primary optic, is mounted on substrate 62. LED 60 may contain a single color die or may contain multiple dies, each of which may be of differing colors. The light output from the dies in LED 60 enters collimating and mixing optic 80 at light entry port 82. Collimating and mixing optic 80 may be a solid optic using total internal reflection (TIR) to direct the light or may be a hollow reflective surface. Collimating and mixing optic 80 may have four sides 86, each of which may be curved with cornered sides 92. The end view of collimating and mixing optic 80 in FIG. 6 combined with side illustration of the collimating and mixing optic 80 in FIG. 5 illustrate details an embodiment of the shape. The combination square sided shape with curved sides provides excellent mixing of the light from the dies 64 in LED 60. A further feature of collimating and mixing optic 64 is that it directs the reflected light to an external focal point which is comparatively close to its output port 84 of the collimating and mixing optic 80.

In the embodiments illustrated in FIG. 6 the configuration of the plurality of LED dies 64 in LED 60 is square and aligned with the sides 86 of the collimator 80. In other embodiments the alignment of the dies with the collimator sides may not be aligned, for example as illustrated in FIG. 10. In alternative embodiments of those illustrated in FIG. 6 and FIG. 10 the collimator may have a plurality of slides of three four or more sides. In further embodiments the arraignment of the dies in the LED array may be configured in different shapes and paired with collimators with matching or divergent shapes.

In different embodiments degree of curvature of the sides 86 may vary—flatter for some configurations and more curved for other configurations. Additionally, the sharpness of the corners 92 between the sides may vary among different collimators—sharper for some configurations and rounder for others. The selection of the number of sides and the curvature of the sides and curvature of the corners is/are tradeoffs between the degree of mixing desired and acceptable light loss for a particular configuration or application.

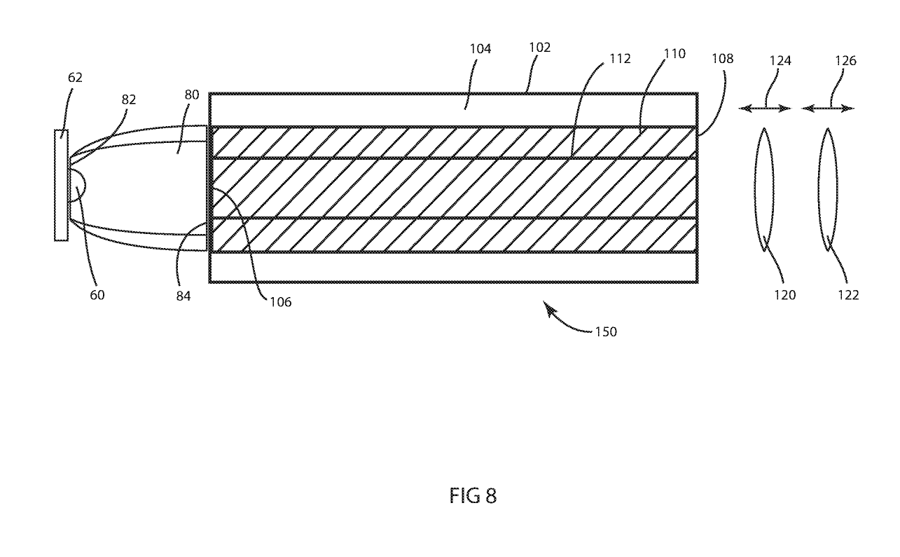

In the embodiment shown in FIG. 5, the reflected light exits collimating and mixing optic 64 at port 84 and enters light integrator optic 102 at its entry port 106. Light integrator 102 is a device utilizing internal reflection so as to collect, homogenize and constrain and conduct the light from collimating and mixing optic 80. Light integrator 102 may be a hollow tube with a reflective inner surface such that light impinging into the entry port may be reflected multiple times along the tube before leaving at the exit port 108. Light integrator 102 may be a square tube, a hexagonal tube, a heptagonal tube, an octagonal tube, a circular tube, or a tube of any other cross section. In a further embodiment light integrator 102 may be a solid rod constructed of glass, transparent plastic or other optically transparent material where the reflection of the incident light beam within the rod is due to total internal reflection (TIR) from the interface between the material of the rod and the surrounding air. The integrating rod may a square rod, a hexagonal rod, a heptagonal rod, an octagonal rod, a circular rod, or a rod of any other cross section. Integrator embodiments with a polygonal cross section have reflective sides 110 and corners 112 between the reflective sides as seen in FIG. 5 which includes a side cross sectional view of the integrator 102 and more easily seen in FIG. 7 a front exit port view of the integrator 102.

In a yet further embodiment the light integrator 102 may have a straight sided square cross section at the entrance port and a straight sided polygonal cross section with more than four sides at the exit port. The exit port may be pentagonal, hexagonal, heptagonal, octagonal, or have any other integral number of sides.

A feature of a light integrator 102 which comprises a hollow or tube or solid rod where the sides of the rod or tube are essentially parallel and the entrance aperture 106 and exit aperture 108 are of the same size is that the divergence angle of light exiting the integrator 102 at exit port 108 will be the same as the divergence angle for light entering the integrator 102 at entry port 106. Thus a parallel sided integrator 102 has no effect on the beam divergence and will transfer the position of the focal point of collimating and mixing optic 80 at its exit aperture 84 to the integrator's 102 exit aperture 108. The light exiting integrator 102 will be well homogenized with all the colors of LED 60 mixed together into a single colored light beam and may be used as our output, or may be further modified by downstream optical systems.

Integrator 102 may advantageously have an aspect ratio where its length is much greater than its diameter. The greater the ratio between length and diameter, the better the resultant mixing and homogenization will be. Integrator 66 may be enclosed in a tube or sleeve 104 which provides mechanical protection against damage, scratches, and dust.

FIG. 8 illustrates a further embodiment of the invention. Elements LED 60, substrate 62, collimating and mixing optic 80, integrator 102, are as described above for FIG. 5, FIG. 6 and FIG. 7. In this embodiment the homogenized and focused light exiting from integrator 66 is directed through lens system 120 and 122. Lenses 120 and 122 may be independently movable 124 and 126 along the optical axis so as to provide beam angle control over the light beam. Because the focal point of collimating and mixing optic 80 is short, a small motion of lenses 120 and 122 may cause a large change in beam angle. In one embodiment movements 124 126 of 10 mm in the position of lenses 120 and/or 122 may cause a change in beam angle from 5° to 50°. Thus providing an improved variable beam angle or zoom to an automated LED luminaire.

In further embodiments, lenses 120 and 122 may form an achromatic optical system such that it provides the same degree of beam angle change to long wavelength red light as it does to short wavelength blue light and thus avoids chromatic aberration. This ensures that the beams from the different colors of LED dies 64 in LED 60 are all the same size resulting in a uniformly colored combined beam. In yet further embodiments any number of lenses may be used as the lens system. In all cases, lenses may contain one or more optical elements. Lenses 120 and 1222 are illustrated herein as bi-convex lenses however the invention is not so limited and lenses 120 and 122 may be any shaped optical element as well known in the art.

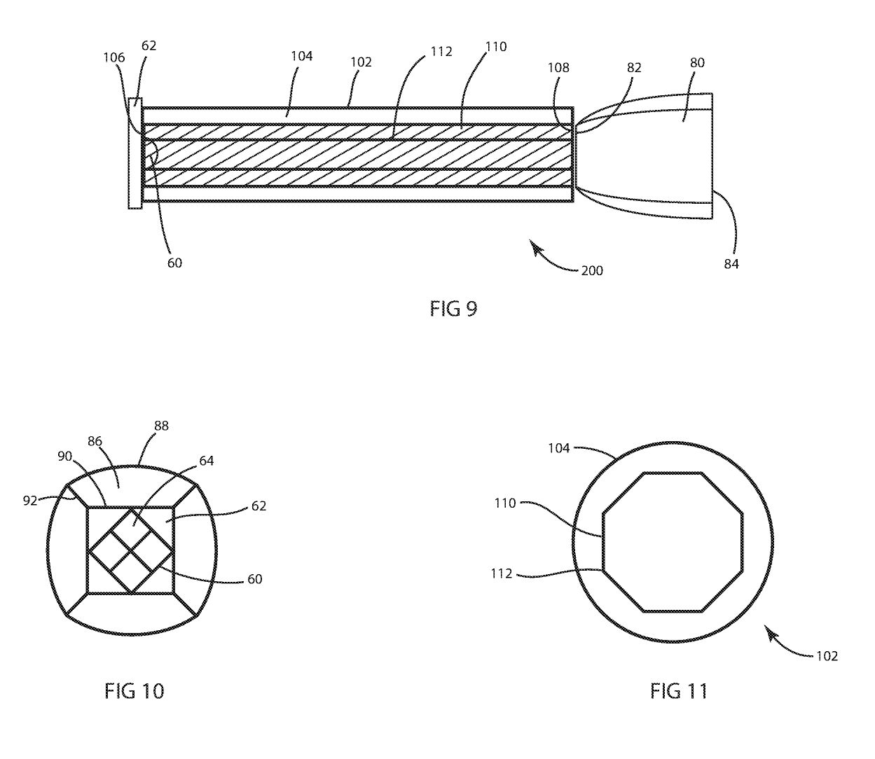

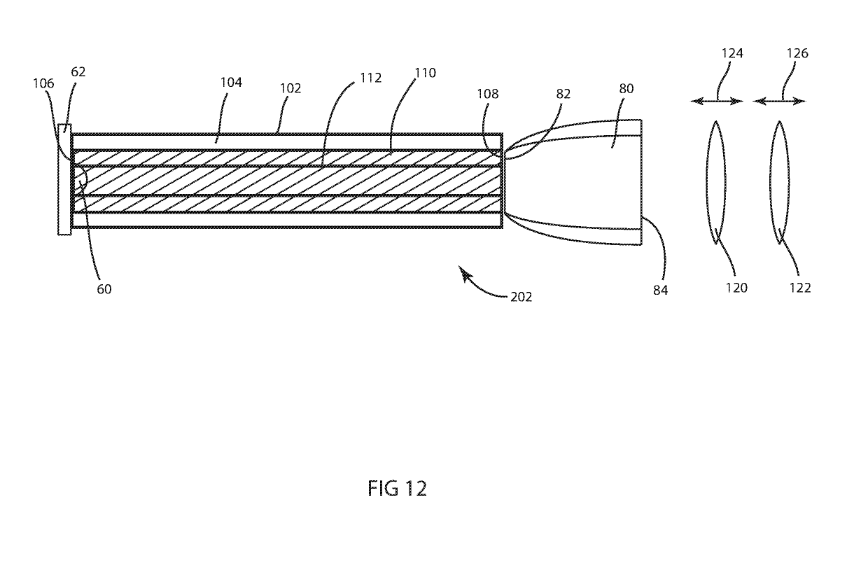

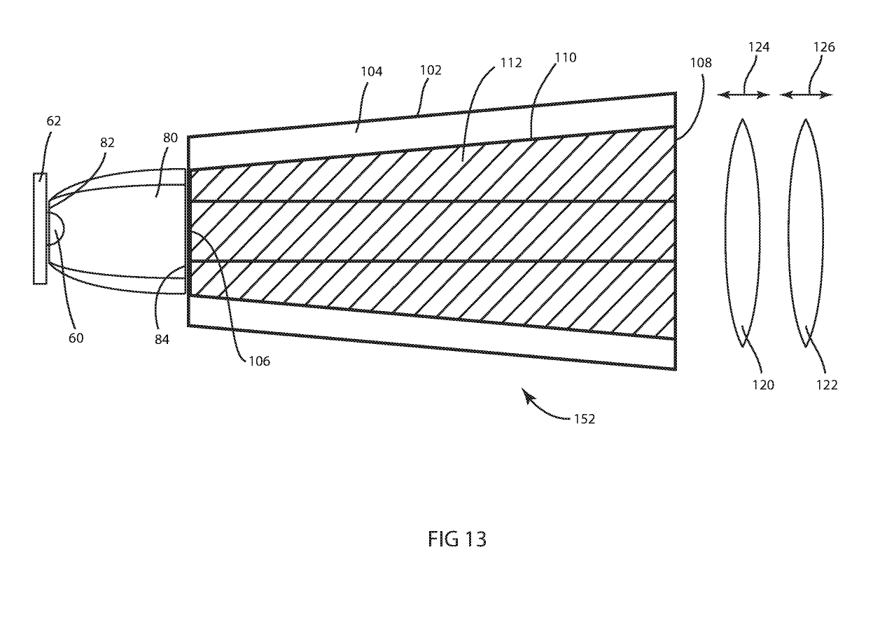

FIG. 9 illustrates an embodiment of the optical system of the invention. LED 60, which may include a primary optic, is mounted on substrate 62. LED 60 may contain a single color die 64 or may contain multiple dies 64, each of which may be of differing colors. The light output from the dies 64 in LED 60 enters light integrator optic 102 at entry port 106. Light integrator 102 may be of the same construction and configuration as in the embodiment illustrated in FIG. 5. Light integrator 102 is a device utilizing internal reflection so as to collect, homogenize and constrain and conduct the light to the entry port 82 of collimating and mixing optic 80. Light integrator 102 may be a hollow tube with a reflective inner surface such that light impinging into the entry port 106 may be reflected multiple times along the tube before leaving at the exit port 108. Light integrator 102 may be a square tube, a hexagonal tube, a heptagonal tube, an octagonal tube, a circular tube, or a tube of any other cross section. In a further embodiment light integrator 102 may be a solid rod constructed of glass, transparent plastic or other optically transparent material where the reflection of the incident light beam within the rod is due to total internal reflection (TIR) from the interface between the material of the rod and the surrounding air. The integrating rod may a square rod, a hexagonal rod, a heptagonal rod, an octagonal rod, a circular rod, or a rod of any other cross section.

A feature of a light integrator 102 which comprises a hollow or tube or solid rod where the sides of the rod or tube are essentially parallel and the entrance aperture 106 and exit aperture 108 are of the same size is that the divergence angle of light exiting the integrator 102 exit port 108 will be the same as the divergence angle for light entering the integrator 102 at entry port 106 from LED 60. Thus a parallel sided integrator 102 has no effect on the beam divergence and will transfer the light from LED 60 to its exit aperture 108. The light exiting integrator 102 will be well homogenized with all the colors of LED 60 mixed together into a single colored light beam.

Integrator 102 may advantageously have an aspect ratio where its length is much greater than its diameter. The greater the ratio between length and diameter, the better the resultant mixing and homogenization will be. Integrator 102 may be enclosed in a tube or sleeve 104 which provides mechanical protection against damage, scratches, and dust.

Light exiting integrator 102 at exit port 108 enters collimating and mixing optic 80 at its entry port 82. Collimating and mixing optic 80 may be of the same construction and configuration as the collimating and mixing optic in embodiment illustrated in FIG. 5. Collimating and mixing optic 80 may be a solid optic using total internal reflection (TIR) to direct the light or may be a hollow reflective surface. Collimating and mixing optic 80 may have four sides, each of which may be curved. The side view of collimating and mixing optic 80 included in FIG. 9 and the end view of collimating and mixing optic 80 in FIG. 10 illustrate the detail of this shape. The combination square sided shape with curved sides provides further mixing of the light from the dies in LED 60 as homogenized by integrator 102. A further feature of collimating and mixing optic 80 is that it directs the reflected light to an external focal point which is comparatively close to its output face.

In the embodiment shown in FIG. 9 the reflected light exits collimating and mixing optic 80 at exit port 84 and may be used as our output, or may be further modified by downstream optical systems.

FIG. 8 illustrates a further embodiment of the invention. Elements LED 60, substrate 62, collimating and mixing optic 80, integrator 102, can be as described above. In this embodiment the homogenized and focused light exiting from collimating and mixing optic 64 is directed through lens system 120 and 122. Lenses 120 and 122 may be independently movable along the optical axis so as to provide beam angle control over the exiting light beam. Because the focal point of collimating and mixing optic 80 is short, a small motion of lenses 120 and 122 may cause a large change in beam angle. In one embodiment a movement of 10 mm in the position of lenses 120 and/or 122 may cause a change in beam angle from 5° to 50°. Thus providing an improved variable beam angle or zoom to an automated LED luminaire.

In further embodiments, lenses 120 and 122 may form an achromatic optical system such that it provides the same degree of beam angle change to long wavelength red light as it does to short wavelength blue light and thus avoids chromatic aberration. This ensures that the beams from the different colors of LED dies in LED 60 are all the same size resulting in a uniformly colored combined beam. In yet further embodiments any number of lenses may be used as the lens system. In all cases, lenses may contain one or more optical elements. Lenses 120 and 122 are illustrated herein as bi-convex lenses however the invention is not so limited and lenses 120 and 122 may be any shaped optical element as well known in the art and may include any number of lenses including a single lens. This applies to any of the embodiments discussed above

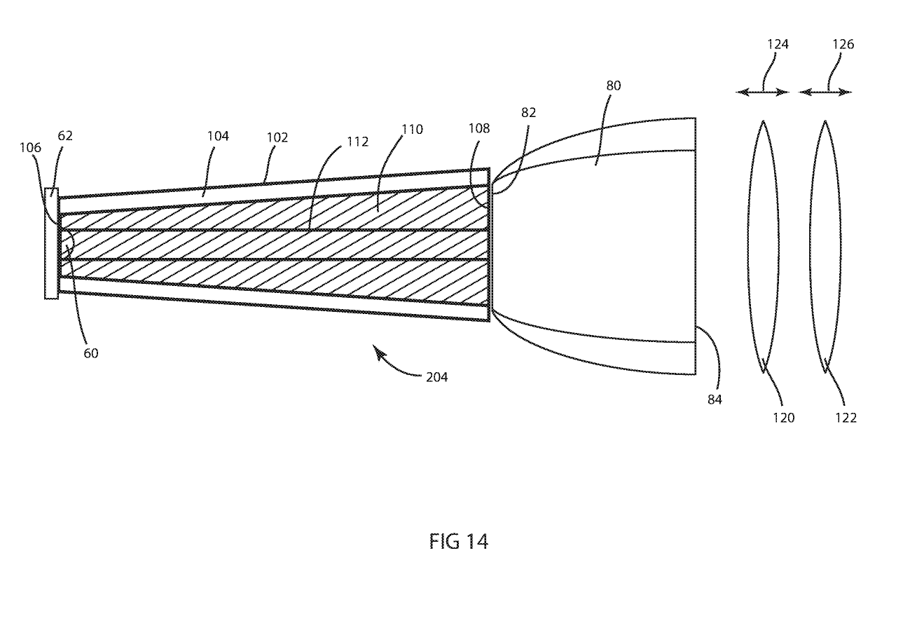

FIG. 13 and FIG. 14 illustrate further alternative embodiments of LED luminaires. In both of these embodiments the light integrator 102, whether solid or hollow, has sides 110 which are tapered so that entrance aperture 106 is smaller than the exit aperture 108. The advantage of this structure is that the divergence angle of light exiting the integrator 102 at exit port 108 will be smaller than the divergence angle for light entering the integrator 102 at entry port 106. The combination of a smaller divergence angle from a larger aperture serves to conserve the etendue of the system. Thus a tapered integrator 102 may provide similar functionality to a condensing optical system. Therefore some embodiments may not include optical elements 120 122 as discussed above while other embodiments may include such elements as discussed above with regard to embodiments with non-tapered integrators.

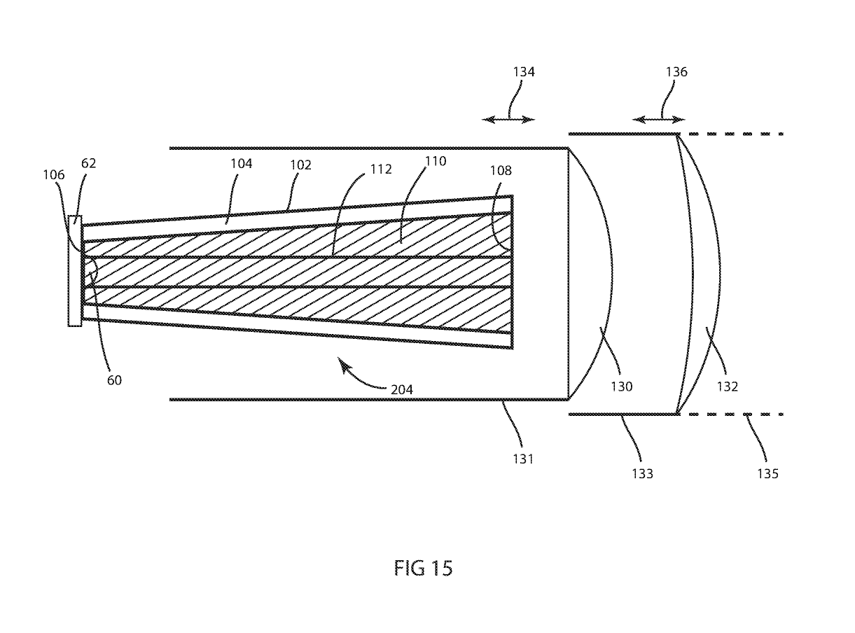

FIG. 15 illustrates a further alternative embodiment of LED luminaires. In this embodiment the light integrator 102, whether solid or hollow, and with any number of sides, or with a square entry port 106 and a polygonal exit port 108 has sides 110 which are tapered so that entrance aperture 106 is smaller than the exit aperture 108. The advantage of this structure is that the divergence angle of light exiting the integrator 102 at exit port 108 will be smaller than the divergence angle for light entering the integrator 102 at entry port 106. The combination of a smaller divergence angle from a larger aperture serves to conserve the etendue of the system. Thus a tapered integrator 102 may provide similar functionality to a condensing optical system. Therefore some embodiments may not include optical elements 120 122 as discussed above while other embodiments may include such elements as discussed above with regard to embodiments with non-tapered integrators. Additionally this embodiment may alternately utilize lenses 130 and 132 as optical elements providing condensing, beam angle control, and focusing functionality as described above as a replacement for the collimating and mixing optic used in earlier embodiments. Lenses 130 and 132 may be meniscus lenses, plano convex lenses, bi-convex lenses, or other lenses as well known in the art. In the embodiment illustrated lens 130 is a plano-convex lens, and lens 132 is a meniscus lens. FIG. 15 also shows optional spill reducing elements 131 and 133. Spill reducing elements 131 and 133 may comprise hollow opaque thin walled tubes which are attached to, and move with, optical elements 130 and 132 respectively. These tubes reduce light spill from the exit port 108 which may impinge on adjacent light integrators and their associated optical systems. Spill reducing element 131 may be of a smaller diameter than spill reducing element 133 such that optical element 130 and its attached spill reducing element 131 may move within spill reducing element 133 such that optical elements 130 and 132 may move to be adjacent. An external further additional spill reducing element 135 may also be added to and may move with lens 132. Lenses 130 may be moved as shown by arrow 134, and lens 132 may be moved as shown by arrow 136. Such movement allows changing the focal length, and thus the beam angle of the output light beam. Lenses 130 and 132 may move together as a pair with a single actuator, or, in a further embodiment, may move independently each with its own actuator.

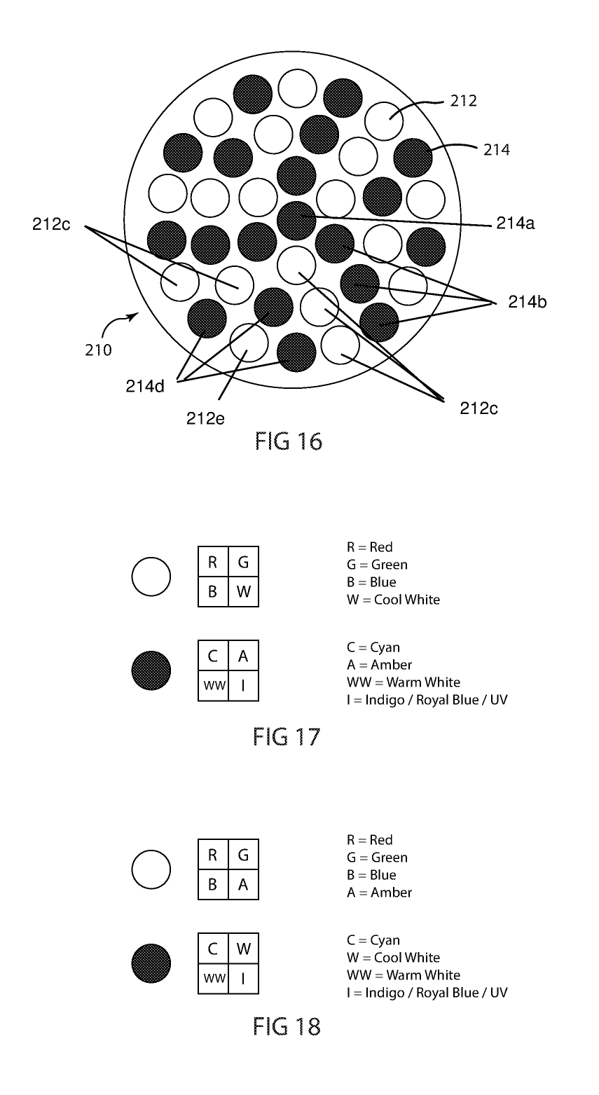

FIG. 16 shows an LED layout for a luminaire. In this embodiment two differing LED packages are used, each package is a standard LED package containing four dies, however the mix of colors within each of the two packages differs. It is well known to use more than four colors of LED dies in an LD luminaire in order to improve the color rendering of the mixed color output, and to increase the available gamut of possible mixed colors. U.S. Pat. No. 6,683,423, U.S. Pat. No. 7,023,543, and U.S. Pat. No. 7,227,634 all to Cunningham describe utilizing five or more different colors of narrow band LED emitters in order to more accurately emulate the spectrum of a natural light source. However, Cunningham does not explain or describe how such a system might perform optically and how these different emitters may be effectively homogenized into a single colored light beam. Nor does he explain or solve the problems of packaging and dealing with this many emitters optically.

Utilizing a standard four die LED package but with multiple different packages each containing different die mixes has significant economic and practical advantages. Firstly at least one of the packages might be an off-the-shelf mix of colors, such as common LED packages containing Red, Green, Blue, and Cool White dies or others containing Red, Green, Blue, and Amber dies. It has a further advantage that optical systems designed and developed for such four die LED packages may be used, with no requirement for customizing the optical systems. For example, a number of the existing LED luminaires produced by Robe Lighting utilize four die LED packages and are capable of utilizing different packages with different mixes of dies.

As an example, FIG. 16 shows an LED luminaire 210 using two different LED packages, each containing four LED dies. First LED package 212, and second LED package 214 in a layered spiral spoked configuration. The first layer is comprised of the central hub 214a and spiral spoke layer of dies 214b of a first type of configuration. Followed by a second spiral spoke layer of dies 212c of a second type of packaged leds followed by a third spoke layer of dies 214d of the first time followed by a fourth spoke layer of dies 212e of the second type of die packages.

Both LED packages 212 and 214 may use the same collimating and homogenizing systems. In the embodiment illustrated the two packages are used in approximately equal numbers, however the invention is not so limited and the first and second LED packages may be used in any ratio. In a further embodiment there are a larger number of LED package 212 and a smaller number of LED package 214 such that the standard RGBW dies are in the majority. The first and second LED packages 212 and 214 may be evenly distributed across luminaire 210 such that the light from each first package type merges and mixes with that from surrounding second package type, and vice-versa.

In yet further embodiments more than two different package types may be used, each containing a differing mix of LED dies.

FIGS. 17 and 18 show examples of the mix of LED dies that may be used in two LED packages. In FIG. 17 the first LED package contains Red, Green, Blue and Cool White LED dies, which is a standard common configuration. The second LED package contains Cyan, Amber, Warm White and Indigo/Royal Blue/UV dies. This mix of LED dies is not a standard mix available in a four package dies. The combination of all eight colors, Red, Green, Blue, Cool White, Cyan, Amber, Warm White and Indigo/Royal Blue/UV represents a broad mix of colors with a large mixing color gamut and advantageous color rendering, preferable for illuminating critically colored objects such as human skin tones, theatrical costumes and scenery, or works of art.

In FIG. 18 the first LED package contains Red, Green, Blue and Amber LED dies, which is a standard available configuration. The second LED package contains Cyan, Cool White, Warm White and UV dies. This mix of LED dies is not a standard mix available in a four package dies. The combination of all eight colors again represents a broad mix of colors with a large mixing color gamut and advantageous color rendering.

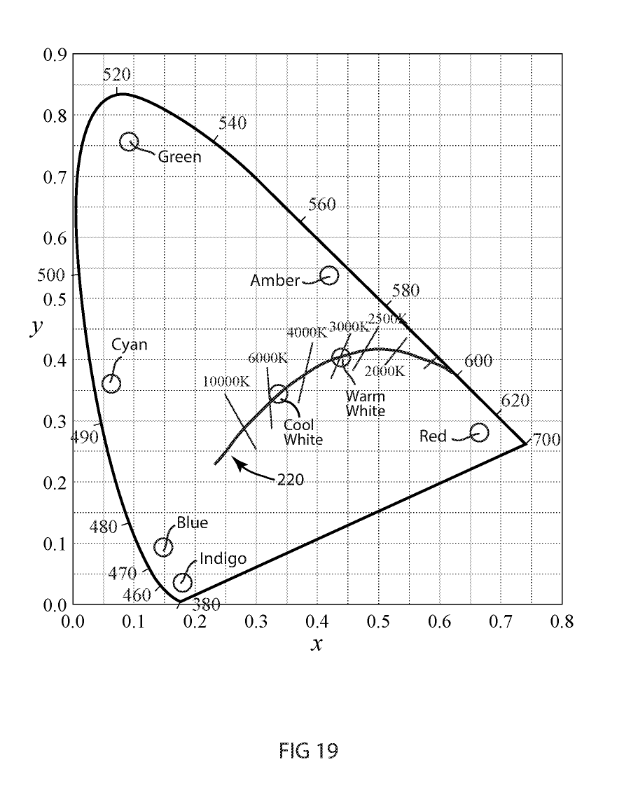

FIG. 19 shows a possible distribution of LED colors that may be used in an embodiment of the invention on a standard CIE color chart. It can be seen that a color mix using Red, Amber, Green, Cyan, Blue and Indigo emitters provides a color gamut close to the edge of the CIE chart, and thus provides a broad and realistic range of colors.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

What is claimed is:

1. An LED array luminaire comprised of a layered spiraled spoked configuration of two different LED die configurations.
